(19) United States
(12) Patent Application Publication
(10) Pub. No.: US 2021/0006130 A1
(43) Pub. Date: Jan. 7, 2021

(54) OPTIMISED OIL PRESSURE REGULATION

(71) Applicant: SAFRAN ELECTRICAL & POWER, Blagnac Cedex (FR)

(72) Inventor: Paul David Flower, Buckinghamshire (GB)

(21) Appl. No.: 16/976,192

(22) PCT Filed: Feb. 18, 2019
(86) PCT No.: PCT/EP2019/054006

§ 371 Date: Aug. 27, 2020

(30) Foreign Application Priority Data
Feb. 28, 2018 (GB) 1803278.9

(51) Int. Cl. H02K 9/19; H02K 9/26; H02K 9/24; B64D 33/08

(52) U.S. Cl. CPC H02K 9/19; H02K 9/26; H02K 7/1807; B64D 33/08; H02K 9/24

(57) ABSTRACT

A coolant system of a generator arranged to be driven by an aircraft engine. The coolant system includes a fluid circuit with a fluid therein, the fluid for cooling an electricity generator, and a pump, arranged to provide a flow of fluid around the fluid circuit to deliver coolant to at least one cooled component of the generator, via a cooler. The system also includes a fluid control device located between the pump and the cooler in the fluid circuit. The fluid control device is configured to selectively direct the fluid provided by the pump away from the cooler in dependence on a measured pressure in the fluid circuit. The measured pressure is derived from a measured point in the fluid circuit, the measured point being remote from the fluid control device.

The present invention relates to coolant systems. In particular, the invention relates to coolant systems with optimised pressure regulation, for use in cooling generators connected to aircraft engines.

### BACKGROUND TO THE INVENTION

Electrical generators have both an operating temperature range (within which they can operate) and an optimum temperature range (within which they operate most efficiently). In use, electrical generators create heat due to inefficiencies in generation. Electrical generators are typically cooled by a circulating fluid to ensure that they are kept within their operating temperature range, and preferably kept within their optimum temperature range.

Aircraft propulsion systems typically comprise an engine, such as a turbine or jet engine, which may be connected to an electrical generator. The electrical generator is typically formed of an assembly of magnetic circuit components, comprising a rotor and a stator. Generally, aircraft engine electrical generators are cooled using a fluid—typically oil for large aircraft generators—by circulating the fluid which is driven by a mechanical pump. The pump itself is typically driven from the rotor shaft of the electrical generator. In other implementations, such as smaller generators, air cooling can be implemented using a fan.

When the generator is operating at lower speeds, for a given electrical load currents in the windings of the generator rotor will be higher, which in turn generates more heat due to resistance. Therefore, more cooling is required at these lower speeds. Similarly, if the generator is operating at lower speeds, the rotational speed of the pump will also be lower, and thus the rate at which the oil flows around the circuit will be lower. Conversely, when the generator is operating at higher speeds, currents are lower, and thus less heat is generated. However, the drive speed delivered at the pump is higher, increasing the rate at which the oil flows around the circuit. In order to provide sufficient cooling at the low-flow-rate, high current operating conditions, the coolant pump will typically provide well over the flow rate required for cooling at high speeds.

In known systems, oil flow through the generator is regulated by using a pressure relief valve at a point where the oil is first used to cool the generator. This ensures that oil flow through the generator is kept within a selected design flow rate range across the entire speed range, by venting any excess oil back to an oil reservoir or sump. Typically, this pressure relief valve is set to around 60 psi (pounds per square inch). However, in known systems, it has been found that a significant proportion of the pressure drop in the coolant system, which can be in excess of 120 psi when operating the engines at cruise speeds and higher, occurs in the remotely mounted cooler and associated pipework of the cooling system. Since the hydraulic power provided by the pump is the flow rate multiplied by the outlet pressure, any reduction in this pressure drop will lead directly to a reduction in pump power consumption and thus an improvement in efficiency.

Therefore, an improved way of regulating oil pressure in coolant systems is required.

### SUMMARY OF THE INVENTION

A first aspect of the present invention provides a coolant system of a generator arranged to be driven by an aircraft engine, the coolant system comprising a fluid circuit with a fluid therein, the fluid for cooling an electricity generator located in the fluid circuit, a pump, arranged to provide a flow of fluid around the fluid circuit to deliver coolant to at least one cooled component of the generator, via a cooler located in the fluid circuit between the pump and the at least one cooled component, a fluid control device located between the pump and the cooler in the fluid circuit, wherein the fluid control device is configured to selectively direct at least a proportion of the flow of fluid provided by the pump away from the cooler in dependence on a measured pressure in the fluid circuit, wherein the measured pressure is derived from a measured point in the fluid circuit remote from the fluid control device.

The at least one cooled component may be any heat generating component of the power generating means. For example, the at least one cooled component may include a magnetic heat generating component, an electric heat generating component, an electro-magnetic heat generating component, a mechanical heat generating component or any active generating component of the generator.

The measured point is preferably disposed between the cooler and the at least one cooled component in the fluid circuit.

The pressure of the fluid is measured at a point downstream of the cooler before the fluid passes through a part of the at least one cooled component, that is, the point at which pressure regulation is required. However, the means to regulate the pressure, the fluid control device, is located upstream of the cooler. As such, the amount of fluid directed into the cooler is controlled so as to regulate the fluid pressure at the cooled component.

The at least one cooled component may comprise a rotor, or stator or both a rotor and a stator.

The fluid control device may comprise an inlet configured to receive at least a part of the fluid flow provided by the pump, a first outlet configured to direct flow to the cooler and a second outlet configured to direct flow away from the cooler, wherein the device is configured to divide the flow received at its inlet between the first outlet and the second outlet in dependence on the measured pressure. That is, the fluid control device directs flow in dependence on the pressure measured at the point of pressure regulation

The fluid control device may comprise a metering port configured to be in fluid communication with the measured point and to selectively direct the proportion of the flow of fluid provided by the pump to the cooler in dependence on the measured pressure, which is delivered to the pressure port.

The coolant system may further comprise a fluid reservoir for supplying fluid to the pump and receiving fluid from the fluid circuit, wherein the second outlet of the fluid control device is configured to direct flow to the reservoir.

The system may further comprise a filter located between the pump and the cooler in the fluid circuit, the filter being located before or after the fluid control device.

The system may further comprise a pressure relief valve configured to allow at least a proportion of the flow provided by the pump to bypass the cooler when fluid pressure at the pressure relief valve reaches a threshold value.

The fluid circuit may be configured to deliver a flow of the fluid from the cooler first through a rotor of the generator and subsequently through a stator of the generator. In this respect, the pressure may be measured at a point before the fluid flows through the rotor, or at a point before the fluid flows through the stator.

Alternatively, the fluid circuit may be configured to deliver a flow of the fluid from the cooler first through a stator of the generator and subsequently through a rotor of the generator. Similarly, the pressure may be measured at a point before the fluid flows through the stator, or at a point before the fluid flows through the rotor.

The fluid control device may comprise a spool movable within a cavity to direct at least a proportion of the flow of fluid provided by the pump away from the cooler.

The spool may be biased in a first direction by a biasing means and wherein the measured pressure acts upon the spool to bias the spool against the biasing means in a second direction opposite the first direction.

The biasing means may be configured to bias the spool toward a positon in which the fluid flow provided by the pump is directed toward the cooler.

The measured pressure provided to the spool may act to bias the spool toward a position in which the fluid flow provided by the pump is directed away from the cooler.

The measured pressure provided to the spool may act to bias the spool toward a position in which the fluid flow provided by the pump is directed toward the reservoir.

A second aspect of the present invention provides an aircraft propulsion system comprising a coolant system as outlined above.

A third aspect of the present invention provides an aircraft comprising an aircraft propulsion system, the aircraft propulsion system comprising a coolant system as outlined above.

### BRIEF DESCRIPTION OF THE DRAWINGS

Further features and advantages of the present invention will become apparent from the following description of embodiments thereof, presented by way of example only, and by reference to the drawings, wherein:

FIG. 1 shows a coolant system in accordance with the prior art;

FIG. 2 shows a coolant system in accordance with an embodiment of the invention; and

FIG. 3 shows a component of the coolant system of FIG. 2.

### DETAILED DESCRIPTION OF PREFERRED EMBODIMENTS

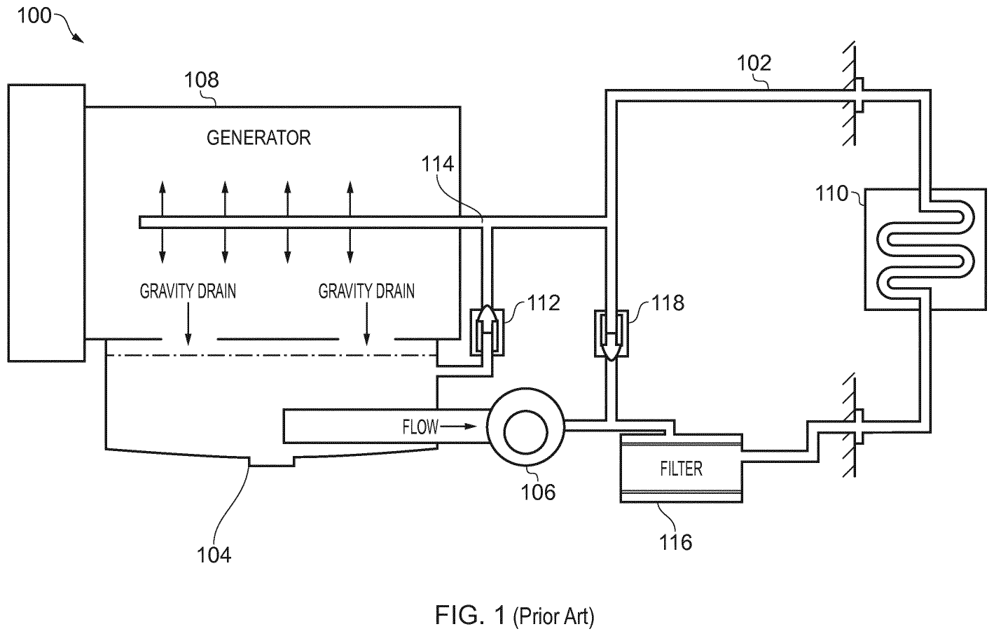

FIG. 1 illustrates a coolant system 100 which is known in the prior art for use in aircraft propulsion systems. The coolant system 100 comprises a coolant circuit 102. The coolant circuit 102 contains a coolant fluid (not shown) which can be circulated around the coolant circuit 102. In this illustrated example, the coolant can be oil, although any suitable coolant can be used. The coolant is typically a liquid. The coolant can be circulated to and from a coolant reservoir 104, commonly known as a sump.

The coolant system 100 also comprises a pump 106 arranged within the coolant circuit 102. The pump is configured to circulate a flow of the coolant around the coolant circuit 102.

The coolant system 100 also comprises an electrical generator 108, which is cooled by the coolant circuit 102. In this respect, the electrical generator 108 is arranged in thermal communication with the coolant circuit 102, such that excess heat can be transferred from the electrical generator 108 to the coolant fluid. Typically, to achieve this effect, the coolant runs through one or more components of the generator, and more typically through one or more heat generating components of the generator. Heat generating components of the generator are typically those which generate heat due to electrical resistance during operation of the generator. The electrical generator 108 typically comprises a rotating component, known as a rotor, and/or a stationary component, known as a stator (not shown). It is these components in particular that the coolant circuit 102 is used to cool, though other components of the generator may be cooled in addition to or in place of those components of the generator.

The coolant system 100 also comprises a cooler 110 located in the coolant circuit 102. This is typically located between the pump 106 and the generator 108. The pump 106 is configured to pump the coolant fluid towards the generator 108 through the cooler 110. This allows the cooled fluid from the cooler to flow on to the generator to perform its cooling function. A pressure relief valve 112 is provided at the point at which the coolant circuit 102 begins to cool the generator 108. This pressure relief valve 112 operates based on a pressure at its location 114. This point can in this instance be considered a measured pressure point 114 for the pressure relief valve 114 of the prior art arrangement. It is the location of the pressure relief valve and may be co-located with a point at which the coolant circuit 102 begins to cool the generator 108. The pressure relief valve 112 is configured to keep the pressure of the coolant fluid substantially constant at this point, or at least to ‘cap’ the pressure at an upper threshold value, by opening when a chosen pressure level is reached, typically, but not exclusively, 60 psi, for example. By allowing excess coolant fluid from the coolant circuit 102 to return to the reservoir 104, the pressure relief valve 112 provides a substantially constant pressure drop between the point and which the coolant enters and begins to cool the generator and the reservoir/pump inlet. This results in a substantially constant coolant flow through the generator, which gives a predictable rate of removal of heat from the generator.

A filter 116 is also provided to remove unwanted particulates from the coolant fluid. A cold start pressure relief valve 118 may also be provided to direct some of the coolant fluid such that it bypasses the cooler 110. As the oil is more viscous when it is cold, which requires more power from the pump 106, the cold pressure relief valve 118 helps to prevent overloading the system 100, for example, by directing some of the coolant fluid away from the cooler 110 and allowing it to bypass the cooler 110 in the circuit 102.

The prior art coolant system 100 described above is typical of a coolant system in which the fluid pressure is regulated by a standard pressure relief valve. In this instance the pressure relief valve is located substantially at the point at which the coolant circuit enters the cooled components of the generator and begins to cool the cooled components of the generator 108. However, it has been identified that the majority of the pressure drop in a typical coolant system 100 occurs in the cooler 110 in high speed modes of operation, i.e. at the cruising speed of an aircraft in which the generator may be mounted. At higher speeds, the flow rate increases, which in turn causes the pressure at the generator inlet to increase. Consequently, the pressure relief valve opens further to compensate for this increase and thereby keep the flow rate constant. This excess of flow rate at the generator, where the pressure relief valve is located, results in coolant being returned to the sump while bypassing the generator. However, the diverted coolant has still already passed through the cooler once it reaches the bypass valve 112. In order to push excess coolant fluid through the cooler, a large proportion of the power consumed by the pump 106 is wasted driving a high coolant flow rate through a high pressure drop in the cooler 110. One way to try to avoid this drawback of lost power in the cooler would be to move the pressure relief valve to the pump outlet, but this would bring the drawback that, when pressure drops in the cooler are high, for example due to lower temperatures and higher viscosity of the coolant, the pressure relief valve would operate and insufficient coolant flow would be provided to the generator. So, since the pressure drop in the cooler of the system will vary with coolant viscosity, and thus temperature, it is not possible to simply move the pressure relief valve to the pump outlet or another location before the cooler, as this would leave insufficient coolant pressure, at the point at which the coolant enters the cooled components of the generator, to drive sufficient coolant flow through the cooled components of the generator.

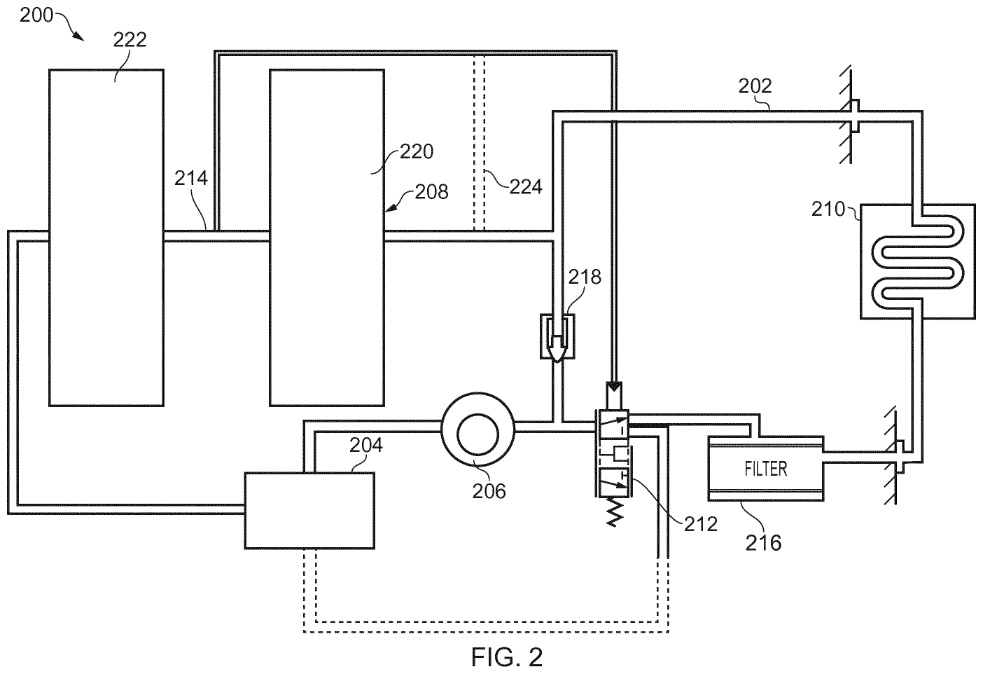

FIG. 2 shows a coolant system 200 according to an embodiment of the invention. Systems according to the invention have been developed to address the problem of excess power being consumed at cruise speeds by excessive coolant flow through the cooler 110 as described above in relation to the prior art cooling system. As described above, at high engine speeds, typically, around half of the coolant reaching the pressure relief valve of the prior art system is returned directly to the oil reservoir without passing through the cooled generator components. This means that a majority of the pressure drop in the cooler is only used to push excess oil through the cooler and on round the circuit to the pressure relief valve, without cooling the generator. This can mean that in certain operational circumstances as little as 10% of the pump power is used to produce useful cooling work, with much of the rest being used to drive excess flow through the cooler.

The coolant system 200 comprises a coolant circuit 202. The coolant circuit 202 contains a coolant fluid (not shown) which can be circulated around the coolant circuit 202. In this illustrated example, the coolant can be oil, which can be circulated to and from a coolant reservoir 204, although any suitable coolant fluid can be used, typically a liquid coolant.

The coolant system 200 also comprises a pump 206 arranged within the coolant circuit 202. The pump is configured to circulate the coolant flow around the coolant circuit 202.

The coolant system 200 also comprises an electrical generator 208, which is cooled by the coolant circuit 202. In this respect, the electrical generator 208 is arranged in or near the coolant circuit 202, such that excess heat can be transferred from the electrical generator 208 to the coolant fluid. Cooled components of the electrical generator are therefore in close thermal contact with the coolant in the coolant circuit. This is typically achieved by passing the coolant through electrical and/or magnetic circuit components of the generator to draw heat from them into the coolant. The electrical generator 208 comprises a rotor 220 and a stator 222.

The coolant system 200 also comprises a cooler 210 located in the coolant circuit 202 between the pump 206 and the generator 208. The pump 206 is configured to pump the coolant fluid towards the generator 208, passing first through the cooler 210.

The coolant circuit 202 is preferably configured such that coolant fluid flows through the rotor 220 first and then through the stator 222, ensuring that the rotor 220 is fed the coldest coolant fluid coming from the cooler 210. However, it will be appreciated that the coolant circuit 202 may also be configured such that coolant fluid flows through the stator 222 first and then through the rotor 220.

A filter 216 is preferably provided to remove unwanted particulates from the coolant fluid. A cold start pressure relief valve 218 can also be provided to direct some of the coolant fluid such that it bypasses the cooler 210 in situations where high viscosity of the coolant, or any blockage in the cooler, causes excessive pressure in the cooler 210.

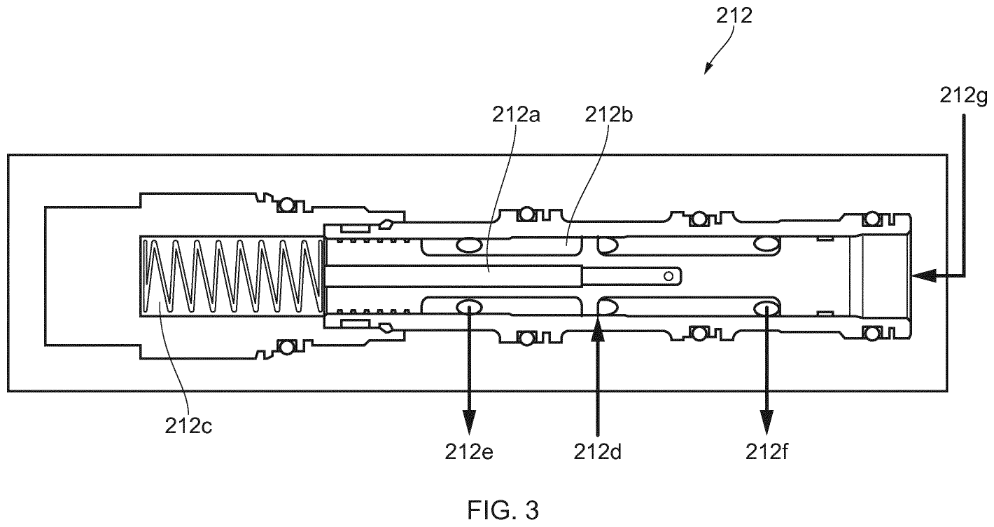

The coolant system 200 further comprises a fluid control device 212 located in the coolant circuit 202 between the pump 206 and the cooler 210. An example of a suitable fluid control device 212 is shown in more detail in FIG. 3. The fluid control device 212 is configured to vary the flow rate of the coolant circuit 202 in order to give the desired pressure across the system 200, in particular across the cooled components of the generator. The fluid control device 212 is preferably a three port valve. The fluid control device 212 in the example shown comprises a spool 212a moveable within a cavity 212b by means of a biasing means such as a spring 212c. The fluid control device 212 comprises an inlet port 212d for receiving coolant fluid from the pump 206, a first outlet port 212e for directing coolant fluid towards the cooler 210 and around the coolant circuit 202, a second outlet port 212f for directing coolant fluid back towards the reservoir 204 and a pressure metering port 21g for receiving a measured pressure. The pressure is measured at a point before the coolant fluid passes through one of the components of the generator 208, where coolant pressure regulation is needed most. This configuration allows the point of pressure regulation to be selected anywhere within the generator 208, and is thus not limited to the point at which excess flow is being removed from the circuit 202. For example, the pressure may be measured at a first pressure measurement point 214 located before the coolant fluid cools the stator 222. Alternatively, pressure may be measured at a second measurement point 224 located before the coolant cools the rotor 220. The pressure measurement point 214 is advantageously after the cooler 210 in the coolant circuit 202.

In use, coolant fluid enters the fluid control device 212 from the pump 206 via the inlet port 212d at the centre of the fluid control device 212. The piston 212a then moves backwards and forwards within the cavity 212b, acting as a flow splitter so as to direct the coolant fluid through either the first outlet port 212e or the second outlet port 212f in dependence on the measured pressure received at the pressure metering port 212g. When the measured pressure gets too high, the high pressure acts on the piston 212a and in turn the piston compresses the spring 212c, moving the spool, such that more coolant fluid is diverted away from the coolant circuit 202 and back to the reservoir 204. That is, more coolant fluid is directed through the second outlet port 212f. This reduces the flow rate around the coolant circuit 202, and hence reduces the pressure at the point of regulation, that is, at the first measurement point 214 or the second measurement point 224 according to the chosen configuration.

When the measured pressure gets too low, the spring 212c biases the piston 212a in the opposite direction, such that more coolant fluid is diverted away from the reservoir 204 and back towards the cooler 210. That is, more coolant fluid is directed through the first outlet port 212e. This increases the flow rate around the coolant circuit 202, and hence increases the pressure at the point of regulation, that is, at the first measurement point 214 or the second measurement point 224. The net result will be to provide an approximately constant oil pressure at the point of pressure regulation.

By measuring the pressure at the point at which regulation is required, that is, downstream of the cooler 210, preferably at a point at which the coolant fluid is used to cool the generator 208, while controlling the flow direction upstream of the cooler 210, that is, before the coolant fluid enters the cooler 210, only the minimum amount of coolant fluid required will pass through the cooler 210. As such, the pressure drop in the cooler 210 will be kept to a minimum, thus significantly reducing the power consumption of the pump 206. This will result in a significant reduction in power consumption of the cooling system of the generator, since excess flow through the cooler is avoided.

Various modifications, whether by way of addition, deletion and/or substitution, may be made to all of the above described embodiments to provide further embodiments, any and/or all of which are intended to be encompassed by the appended claims.

1. A coolant system of a generator arranged to be driven by an aircraft engine, the coolant system comprising:
a fluid circuit with a fluid therein, the fluid for cooling an electricity generator located in the fluid circuit;
a pump, arranged to provide a flow of fluid around the fluid circuit to deliver coolant to at least one cooled component of the generator, via a cooler located in the fluid circuit between the pump and the at least one cooled component;
a fluid control device located between the pump and the cooler in the fluid circuit,
wherein the fluid control device comprises a valve having an inlet configured to receive at least a part of the fluid flow provided by the pump, a first outlet configured to direct flow to the cooler and a second outlet configured to direct flow away from the cooler, wherein the valve is configured to selectively direct at least a proportion of the flow of fluid provided by the pump away from the cooler by dividing the flow received at its inlet between the first outlet and the second outlet in dependence on a measured pressure in the fluid circuit; and
wherein the measured pressure is derived from a measured point in the fluid circuit, the measured point being remote from the fluid control device.

2. A system according to claim 1, wherein the measured point in the fluid circuit is disposed between the cooler and the at least one cooled component.

3. A system according to claim 1, wherein the at least one cooled component comprises a rotor, or a stator, or both a rotor and a stator.

4. A system according to claim 1, the fluid control device comprising a metering port configured to be in fluid communication with the measured point and to selectively direct the proportion of the flow of fluid provided by the pump to the cooler in dependence on the measured pressure, which is delivered to the metering port.

5. A system according to claim 1, the coolant system further comprising a fluid reservoir for supplying fluid to the pump and receiving fluid from the fluid circuit;
wherein the second outlet of the fluid control device is configured to direct flow to the reservoir.

6. A system according to claim 1, further comprising a filter located between the pump and the cooler in the fluid circuit, the filter being located before or after the fluid control device.

7. A system according any to claim 1, further comprising a pressure relief valve configured to allow at least a proportion of the flow provided by the pump to bypass the cooler when fluid pressure at the pressure relief valve reaches a threshold value.

8. A system according to claim 1, wherein the fluid circuit is configured to deliver a flow of the fluid from the cooler first through a rotor of the generator and subsequently through a stator of the generator.

9. A system according to claim 1, wherein the fluid circuit is configured to deliver a flow of the fluid from the cooler first through a stator of the generator and subsequently through a rotor of the generator.

10. A system according to claim 1, wherein the fluid control device comprises a spool movable within a cavity to direct at least a proportion of the flow of fluid provided by the pump away from the cooler.

11. A system according to claim 10, wherein the spool is biased in a first direction by a biasing means and wherein the measured pressure acts upon the spool to bias the spool against the biasing means in a second direction opposite the first direction.

12. A system according to claim 11, wherein the biasing means is configured to bias the spool toward a position in which the fluid flow provided by the pump is directed toward the cooler.

13. A system according to claim 10, wherein the measured pressure provided to the spool acts to bias the spool toward a position in which the fluid flow provided by the pump is directed away from the cooler.

14. A system according to claim 10, wherein the measured pressure provided to the spool acts to bias the spool toward a position in which the fluid flow provided by the pump is directed toward a fluid reservoir.

15. An aircraft propulsion system comprising a coolant system according to claim 1.

16. An aircraft comprising an aircraft propulsion system, the aircraft propulsion system comprising a coolant system according to claim 1.
